(19) United States
(12) Patent Application Publication
(10) Pub. No.: US 2025/0014771 A1
(43) Pub. Date: Jan. 9, 2025

(54) PRODUCING AC-225 USING GAMMA RADIATION

(71) Applicants: Westinghouse Electric Company LLC, Cranberry Township, PA (US); University of Pittsburgh - of the Commonwealth System of Higher Education, Pittsburgh, PA (US)

(72) Inventors: Michael D. Heibel, Broomfield, CO (US); Brian J. LoPresti, Baden, PA (US); Thomas V. Congedo, Pittsburgh, PA (US)

(73) Assignees: Westinghouse Electric Company LLC, Cranberry Township, PA (US); University of Pittsburgh - of the Commonwealth System of Higher Education, Pittsburgh, PA (US)

(21) Appl. No.: 18/709,397

(22) PCT Filed: Nov. 7, 2022
(86) PCT No.: PCT/US2022/079372

§ 371 Date: May 10, 2024

Related U.S. Application Data
(60) Provisional application No. 63/263,854, filed on Nov. 10, 2021.

(51) Int. Cl. G21G 1/12; G21G 1/00

(52) U.S. Cl. CPC G21G 1/12; G21G 2001/0089

(57) ABSTRACT

Devices, systems, and methods to produce Ac-225 from Ra-226 using gamma-radiation generator are disclosed herein. The gamma radiation generator can utilize an electronic neutron generator or a nuclear reactor to produce high energy prompt-capture gamma-radiation. The Ra-226 is irradiated by the gamma radiation to produce Ra-225, which decays to produce Ac-225. The method of using electronic neutron generator and an irradiation target material such as Gd-157 to produce high energy gamma radiation without using a continuously decaying radioisotope such as Co-60 could significantly reduce the cost and increase the safety associated with the production of high energy gamma radiation and Ac-225.

### CROSS-REFERENCE TO RELATED APPLICATION

This application claims the benefit of and priority under 35 U.S.C. § 119(e) to U.S. Provisional Application No. 63/263,854, titled PRODUCING AC-225 USING A GAMMA-RADIATION GENERATOR TO PRODUCE HIGH ENERGY PROMPT-CAPTURE GAMMA RADIATION, filed Nov. 10, 2021, the disclosure of which is hereby incorporated by reference in its entirety.

### FIELD

The present disclosure is generally related to methods, systems, and devices to produce Ac-225, and more particularly, is directed to methods, systems, and devices to produce Actinium-225 (Ac-225) from Radium-226 (Ra-226) using a high energy prompt-capture gamma-radiation generated by an electronic neutron generator or a nuclear reactor.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In one aspect, a device for producing Ac-225 from Ra-226 is disclosed. The device includes an electronic neutron generator, an irradiation target insert, and a Ra-226 insert. The electronic neutron generator generates a thermal neutron flux from an emission end of the electronic neutron generator. The irradiation target insert includes an irradiation target material to generate gamma radiation in response to exposure to the thermal neutron flux generated by the electronic neutron generator. The irradiation target insert is positioned proximate to the emission end of the electronic neutron generator. The Ra-226 insert includes a Ra-226 target material to produce Ra-225 in response to exposure to the gamma radiation generated by the irradiation target material.

In one aspect, a method for producing Ac-225 from Ra-226 is disclosed. The method includes generating neutron flux using an electronic neutron generator. The method further includes producing gamma radiation by exposing an irradiation target material to the neutron flux. The method further includes producing Ra-225 by irradiating a Ra-226 insert including a Ra-226 target material with the gamma radiation.

In one aspect, a system for producing Ac-225 from Ra-226 is disclosed. The system includes a nuclear reactor and an irradiation target assembly. The nuclear reactor includes a reactor core. The irradiation target assembly is insertable into the reactor core. The irradiation target assembly includes a Ra-226 target insert and extraction device, an irradiation target containment structure, and an outer rabbit sheath. The Ra-226 target insert and extraction device includes a Ra-226 material including Ra-226 and a Ra-226 holder enclosing and sealing the Ra-226 material. The irradiation target containment structure includes an irradiation target material and an irradiation target holder enclosing and sealing the irradiation target material. The irradiation target containment structure at least partially surrounds the Ra-226 target insert and extraction device. The outer rabbit sheath includes a closed end and at least partially surrounds the irradiation target containment structure.

In one aspect, a method for producing Ac-225 from Ra-226 is disclosed. The method includes inserting an irradiation target assembly into a core of a nuclear reactor. The irradiation target assembly includes a Ra-226 material and an irradiation target material. The method further includes generating neutron flux in the core of the nuclear reactor. The method further includes producing gamma radiation by exposing the irradiation target material to the neutron flux. The method further includes producing Ra-225 by irradiating the Ra-226 material with the gamma radiation.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. All of the aspects and embodiments may be combined according to the present disclosure. It is to be expressly understood, however, that the drawings are for the purpose of illustration and description only and are not intended as a definition of the limits of the disclosure.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a cross-section schematic representation of an electronic neutron generator-driven gamma radiation generator, according to one aspect of the present disclosure.

FIG. 2 illustrates a schematic representation of a movable in-core detection system, according to one aspect of the present disclosure.

FIG. 3 illustrates a schematic representation of an isotope production cable assembly drive cable assembly, according to one aspect of the present disclosure.

FIG. 4 illustrates a plan view of a target holder element and a female portion of a quick disconnect that connects the target holder element cable assembly to the drive cable assembly shown in FIG. 3, according to one aspect of the present disclosure.

FIG. 5A illustrates a schematic representation of a cross-sectional view of a system for producing Ac-225 from Ra-226, according to one aspect of the present disclosure.

FIG. 5B illustrates a schematic representation of a detailed cross-sectional view of a Ra-226 irradiation device with Ra-226 irradiation targets for use in the system of FIG. 5A, according to one aspect of the present disclosure.

FIG. 5C illustrates a schematic representation of a detailed cross-section view of a removable Ra-226 insert use in the system of FIG. 5A, according to one aspect of the present disclosure.

FIG. 5D illustrates a schematic representation of a section view along line A-A of the Ra-226 irradiation insert of FIG. 5C, according to one aspect of the present disclosure.

FIG. 6A illustrates a schematic representation of a cross-sectional view of irradiation target assembly insertable into a reactor core of a nuclear reactor, according to one aspect of the present disclosure.

FIG. 6B illustrates a schematic representation of a section view along line B-B of the irradiation target assembly shown in FIG. 6A, according to one aspect of the present disclosure.

The exemplifications set out herein illustrate various aspects of the disclosure, in one form, and such exemplifications are not to be construed as limiting the scope of the disclosure in any manner.

### DETAILED DESCRIPTION

Before explaining various aspects of the articulated manipulator in detail, it should be noted that the illustrative examples are not limited in application or use to the details of disclosed in the accompanying drawings and description. It shall be appreciated that the illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof.

Actinium-225 (²²⁵Ac, Ac-225) is an isotope of actinium. It undergoes alpha decay to francium-221 with a half-life of about ten days, and is an intermediate decay product in the neptunium series (the decay chain starting at ²³⁷Np). Except for minuscule quantities arising from this decay chain in nature, Ac-225 is entirely synthetic.

The decay properties of the radioisotope Ac-225 are favorable for usage in and are increasingly being used to deliver Targeted Alpha Therapy (TAT). Clinical trials have demonstrated the applicability of radio-pharmaceuticals containing Ac-225 to treat various types of cancer. However, the scarcity of this isotope resulting from its necessary synthesis in cyclotrons limits its potential applications. The available supply of Ac-225 is less than the demand.

The present disclosure provides methods, devices, and systems that can be used to produce Ac-225 from gamma irradiation of Radium-226 (Ra-226). Specifically, Ra-226 can be used to produce Radium-225 (Ra-225), which then decays directly to Ac-225. A large supply of Ra-226 may be contained in flowback water from natural gas production processes (e.g., Marcellus Shale natural gas production), as described in the following journal articles: “Co-precipitation of Radium with Barium and Strontium Sulfate and Its Impact on the Fate of Radium during Treatment of Produced Water from Unconventional Gas Extraction,” Environmental Science and Technology Journal, Tieyuan Zhang, Kelvin Gregory, Richard W. Hammack, Radisav D. Vidic, Mar. 26, 2014 (“Zhang-1”); “Analysis of Radium-226 in High Salinity Wastewater from Unconventional Gas Extraction by Inductively Coupled Plasma-Mass Spectrometry”, Environmental Science and Technology Journal, Tieyuan Zhang, Daniel Bain, Richard Hammack, and Radisav D. Vidic, Feb. 2, 2015 (“Zhang-2”); and “Fate of Radium in Marcellus Shale Flowback Water Impoundments and Assessment of Associated Health Risks”, Environmental Science and Technology Journal, Tieyuan Zhang, Richard W. Hammack, and Radisav D. Vidic, Jul. 8, 2015 (“Zhang-3”), each of which is herein incorporated by reference in its entirety.

For example, Zhang-2 and Zhang-3 reported that natural gas extraction from Marcellus Shale generates large quantities of flowback water that contain high levels of salinity, heavy metals, and naturally occurring radioactive material (NORM). This water is typically stored in centralized storage impoundments or tanks prior to reuse, treatment or disposal. Ra-226 is the dominant NORM component in the flowback water. The fate of Ra-226 in three centralized storage impoundments in southwestern Pennsylvania was investigated during a 2.5-year period. Field sampling revealed that Ra-226 concentration in these storage facilities is generally increasing during the reuse of flowback water for hydraulic fracturing. In addition, Ra-226 is enriched in the bottom solids (e.g., impoundment sludge), where it increased from less than 10 pCi/g for fresh sludge to several hundred pCi/g for aged sludge. A combination of sequential extraction procedure (SEP) and chemical composition analysis of impoundment sludge revealed that Barite is the main carrier of Ra-226 in the sludge.

Zhang-2 also reported an improved method combining Inductively Coupled Mass Spectrometry (ICP-MS) with solid-phase extraction (SPE) to separate and purify radium isotopes from the matrix elements in high salinity solutions in the study. This method reduces analysis time while maintaining requisite precision and detection limit. Radium separation is accomplished using a combination of a strong-acid cation exchange resin to separate barium and radium from other ions in the solution and a strontium-specific resin to isolate radium from barium and obtain a sample suitable for analysis by ICPMS. Method optimization achieved high radium recovery (101±6% for standard mode and 97±7% for collision mode) for synthetic Marcellus Shale wastewater (MSW) samples with total dissolved solids as high as 171,000 mg/L. Ra-226 concentration in actual MSW samples with total dissolved solids (TDS) was measured to be as high as 415,000 mg/L using ICP-MS which matched very well with the results from gamma spectrometry. Therefore, a large supply of Ra-226 can be provided from the flowback water generated from the Marcellus Shale natural gas production process.

Diamond et al. “Actinium-225 Production with an Electron Accelerator”, W. T. Diamond and C. K. Ross, Manuscript submitted to Journal of Applied Physics on Jan. 1, 2021, DOI: 10.1063/5.0043509, which is herein incorporated by reference in its entirety, reported that there are growing clinical evidences of the value of targeted alpha therapy (TAT) for treatment of several cancers using alpha emitting isotopes and the lack of availability of the key alpha emitting isotopes, especially Ac-225. Most of the supply of Ac-225 has been from three Th-229 generators that are milked to produce hundreds of mCi of Ac-225 every month. Diamond et al. reported several different routes to produce Ac-225 using electron accelerators. For example, Ac-225 can be produced with medical-isotope cyclotrons with a proton energy of at least 16 MeV using the reaction Ra-226(p,2n)Ac-225. Another method to produce Ac-225 is by using high-energy protons (150 to 800 MeV) for spallation of a thorium target. Ac-225 can also be produced by the photonuclear reaction, Ra-226(y,n)Ra-225. The Ra-225 decays via beta decay to Ac-225 with a half-life of 14.9 days. The photons are produced by an intense beam of electrons with an energy about 25 to 30 MeV. Diamond et al. further reported a technical description of the radium targets and a target chamber that would be capable of producing a yield of four curies of Ra-225 from a 10-day irradiation of one gram of radium segmented into two to four separate encapsulated targets, at a beam power of 20 kW. These targets could be milked to yield nearly four curies of Ac-225. Diamond et al. also described a method to reduce production of Ac-227 to values less than a few parts per million of the yield of Ac-225.

The present disclosure provides methods, devices, and systems to produce a supply of Ac-225 from Ra-226 (e.g., Ra-226 derived from the flowback water from the Marcellus Shale natural gas production process or other similar processes, such as wastewater produced during Uranium mining). The methods, devices, and system can use an electronic neutron generator or a nuclear reactor to generate thermal neutrons that are directed to an irradiation target (e.g., a Gd-157 material). Upon exposure to the thermal neutrons, the irradiation target can produce prompt-capture gamma-radiation. The prompt-capture gamma radiation is used to irradiate Ra-226 to produce Ra-225, which decays to produce Ac-225.

Below, the disclosure first provides various devices, system, and methods for producing gamma radiation using an electronic neutron generator. These devices, system, and methods can be utilized to irradiate Ra-226 with gamma radiation to produce Ra-225. Next, the disclosure provides devices, systems, and methods for inserting and withdrawing an irradiation target into a reactor core. These devices, system, and methods can be utilized insert and withdraw, into a reactor core, an irradiation target assembly configured to irradiate Ra-226 with gamma radiation to produce Ra-225. The disclosure then turns to provide (i) devices, systems, and methods for producing Ac-225 using an electronic neutron generator and (ii) devices, systems, and methods for producing Ac-225 using a nuclear reactor. Further, the disclosure provides details related to an example production rate of Ra-225 and Ac-225 from irradiation of Gd-157 by thermal neutrons.

### Production of Gamma Radiation Using an Electronic Neutron Generator

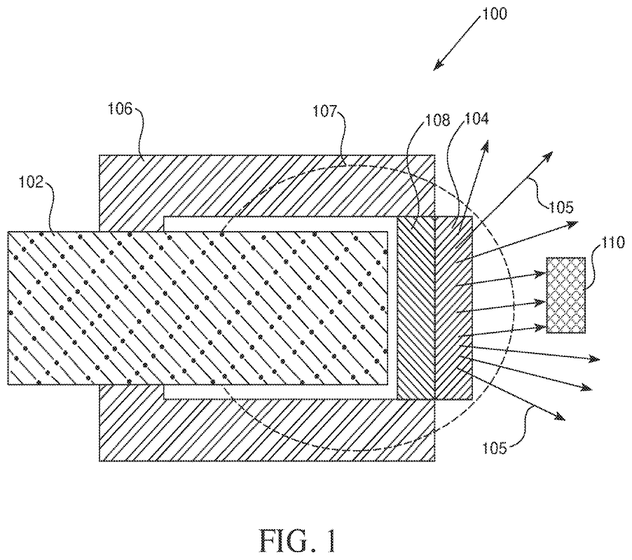

FIG. 1 illustrates a cross-sectional view of a device 100 configured to produce gamma radiation 105 using a neutron generator 102, in accordance with several non-limiting aspects of the present disclosure.

The device 100 includes a neutron generator 102 configured to generate thermal neutrons. In some aspects, the neutron 102 generator can be a commercially available, tubular-shaped electronic neutron generator. The thermal neutrons generated by the neutron generator 102 create a neutron flux field 107.

The device 100 further includes a neutron capture reservoir 104 (e.g., an irradiation target) including a neutron capture material configured to react with incident neutrons to produce gamma radiation. The neutron capture reservoir 104 can be positioned proximate to an end of the neutron generator 102 configured to generate the neutron flux field 107 (e.g., a fusion reaction source end of the neutron generator 102, an emission end of the neutron generator 102). Thus, the thermal neutrons (e.g., the neutron flux field 107) generated by the neutron generator 102 may be directed towards the neutron capture reservoir 104. In response to incident thermal neutrons from the neutron generator 102, the neutron capture reservoir 104 can emit gamma radiation 105 (e.g., prompt neutron capture gamma radiation). Further, the device 100 can be configured such that the emitted gamma radiation 105 is directed towards a target 110 (e.g., a Ra-226 material). As a result, the target 110 is irradiated with gamma radiation 105. Irradiating with gamma radiation 105 a target 110 that includes an Ra-226 material can cause the production of Ra-225, which decays to Ac-225.

In some aspects, the gamma radiation 105 emitted from the neutron capture reservoir 104 is high energy gamma radiation. As used herein, “high energy gamma radiation” can refer to gamma radiation that has an energy of no less than 1.2 MeV, such as no less than 2 MeV, no less than 3 MeV, no less than 4 MeV, no less than 5 MeV, no less than 6 MeV, no less than 7 MeV, or about 7 MeV.

In some aspects, the neutron capture reservoir 104 and/or the neutron capture material included in the neutron capture reservoir 104 can be replicable. In one aspect, the neutron capture material can include a gadolinium material. The gadolinium material may be enriched in gadolinium-157 (sometimes referred to herein as Gd-157). In another aspect, the neutron capture material can include a hafnium material. The hafnium material may be enriched in hafnium-174 (sometimes referred to herein as Hf-174). In yet another aspect, the neutron capture material can have a high thermal neutron cross section. As used herein, a “high thermal neutron cross section” can mean a thermal neutron cross section greater that of hafnium-174. In yet other aspect, the irradiation target material can have a thermal neutron cross section of about 257,000 barns and/or greater than about 257,000 barns.

The neutron capture reservoir 104 can be configured to produce gamma radiation 105 when exposed to the neutron flux field 107 generated by the neutron generator 102. Further, the neutron capture reservoir 104 can be configured to stop producing gamma radiation 105 when the neutron flux field 107 is removed. In other words, the device 100 can be configured such that, when the neutron generator 102 is deactivated, no residual gamma radiation 105 and/or neutron flux 107 is emitted from the device 100. For example, the gadolinium material can include Gd₂O₃ that is enriched in Gd-157. The Gd₂O₃ can be enriched to have at least about 50 wt. %, at least about 60 wt. %, at least about 70 wt. %, at least about 80 wt. %, at least about 85 wt. %, at least about 87 wt. %, at least about 90 wt. %, about 87 wt. % to 100 wt. %, or about 87 wt. % of Gd-157.

As the Gd-157 captures thermal neutrons emitted from the neutron generator 102, a Gd-157m isotope can form. Upon formation, the Gd-157m isotope immediately emits one or more gamma photos that can have a total energy of about 7 MeV. The one or more emitted gamma photons can irradiate the irradiation target 110. Further, because the Gd-157m isotope immediately emits the one or more gamma photons, no residual gamma radiation 105 is emitted by the device after the neutron generator 102 is deactivated.

Still referring to FIG. 1, in some aspects, the device 100 can include a neutron moderator 108 configured to control and/or optimize a level of neutron flux 107 at the neutron capture reservoir 104. The neutron moderator 108 can be positioned between the neutron generator 102 and the neutron capture reservoir 104. The neutron moderator 108 includes a neutron moderator material and a neutron moderator thickness. In some aspects, the neutron moderator material includes graphite, water, heavy water (D₂0), or a combination thereof. In some aspects, the neutron moderator thickness may be adjustable. In yet other aspects, a position of the neutron moderator 108 relative to the neutron generator 102 and/or the neutron capture reservoir 104, the neutron moderator material, and/or the neutron moderator thickness 108 can be optimized to control the level of thermal neutron flux 107 at the neutron capture reservoir 104. This optimization may be performed using various software tools, such as Monte Carlo N-Particle Transport Code (MCNP). In some aspects, the device 100 may include an access door and/or opening to allow for the placement of the neutron moderator 120 and/or other components of device 100.

Still referring to FIG. 1, the device 100 can include shielding 106 that surrounds at least a portion of the device 100 and/or the components thereof. For example, the shielding 106 may be configured to surround an end of an elongated portion of the neutron generator 102 and extend past the end of the elongated portion, surrounding the neutron moderator 108, as shown in FIG. 1. In some aspects, the shielding 106 may continue to extend past the end of the elongated portion of the neutron generator 102 and at least partially encompass the neutron capture reservoir 104. For example, the shielding 106 can be configured to surrounding the sides of the neutron moderator 104 have and have an opening proximate to the target 110. The shielding 106 includes a shielding material. In some aspects, the shielding material can include lead or another similar shielding material suitable for minimizing and/or preventing gamma radiation 106 from escaping the device 100 in an unwanted direction. For example, the shielding 116 may be configured to minimize the amount of gamma radiation 106 that escapes the device 100 from the neutron capture reservoir 104 in a direction away from the target 110. In some aspects, the shielding material can include lead or another similar shielding material suitable for helping to contain the neutron flux field 107 within the device 100. For example, the shielding 106 may be configured to minimize the amount of thermal neutrons (neutron flux field 107) that escape the device 100 from the neutron generator 102 in a direction away from the neutron capture reservoir 104. In some aspects, the shielding 106 may be adjustable. Further, the shielding 106 may be configured to fit around a portion of the outer surface of the neutron generator 102 to minimize neutron 107 and/or gamma radiation 105 exposure to equipment that may be surrounding the device. The shielding 106, neutron moderator 108, and/or neutron capture reservoir 104 may be configured to be used with traditional tubular-shaped electronic neutron generator designs.

Still referring to FIG. 1, an intensity of the gamma radiation 105 field at the irradiation target 110 can be controlled based on operating parameters such as the characteristics of the neutron flux field 107 at the neutron capture reservoir 104, the characteristics of the neutron capture material (e.g., the amount of Gd-157 in the neutron capture reservoir 104), and the distance of neutron capture reservoir 104 from the target 110. Further, the equivalent dose of gamma radiation 105 delivered to the target 110 can be determined based on the above parameters (e.g. based on the intensity of the gamma radiation 105 field and the Gd-157m decay scheme). This determination of the equivalent dose of gamma radiation 105 delivered to the irradiation target 110 may be performed using commercially available software packages, such as MCNP. Accordingly, the device 100 can be configured to deliver a desired dose of gamma radiation 105 to the target 110.

In some aspects, multiple devices 100 can be employed together to produce a gamma radiation field that has an intensity equivalent to the sum of the gamma radiation field intensity produced by an individual device 100. Moreover, multiple devices 100 can be configured in various arrangements to produce a gamma radiation field that is larger and/or has a more uniform intensity compared to an individual device. In some aspects, multiple neutron generators 102 can be employed together to generate multiple (e.g., overlapping) neutron flux fields 107 that are used to produce prompt neutron capture gamma radiation from a common neutron capture reservoir 104.

Additional details related to gamma radiation generation systems, devices, and methods can be found in U.S. Provisional Application No. 63/166,718 and International Application No. PCT/US22/71260, each of which is herein incorporated by reference in its entirety. Any of the disclosed systems, devices, and methods may be employed to produce Ra-225 from Ra-226, according to various aspects of the present disclosure.

Inserting and Withdrawing an Irradiation Target into a Reactor Core

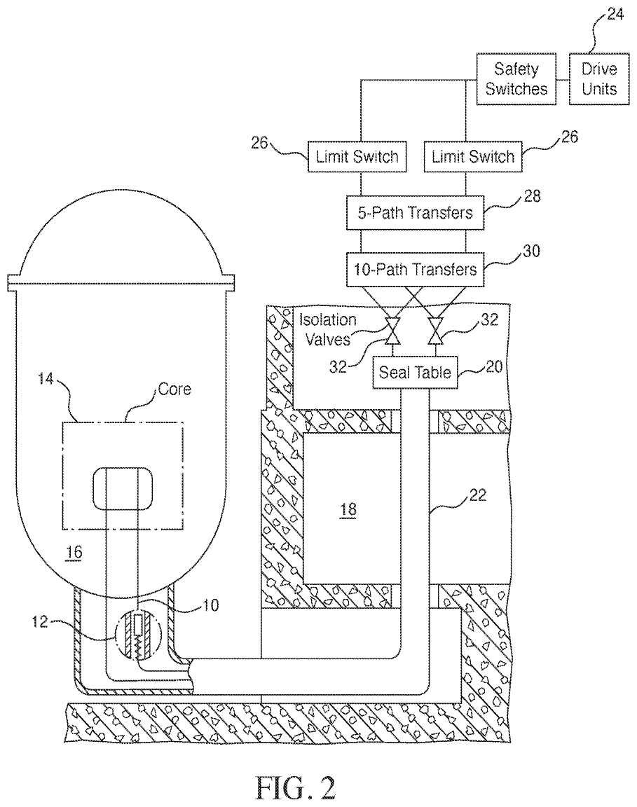

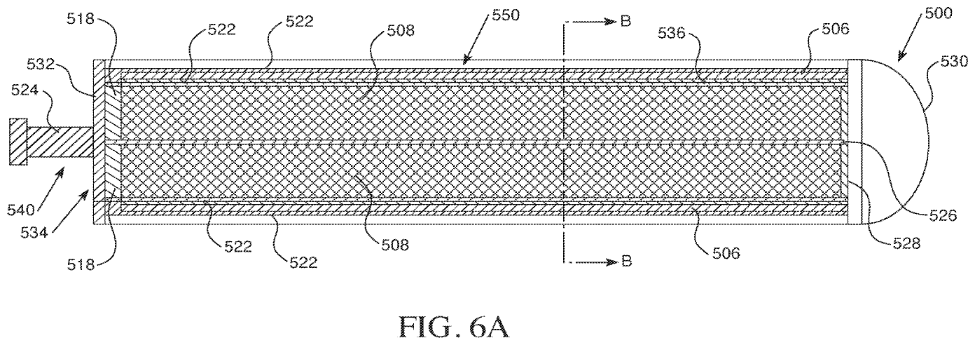

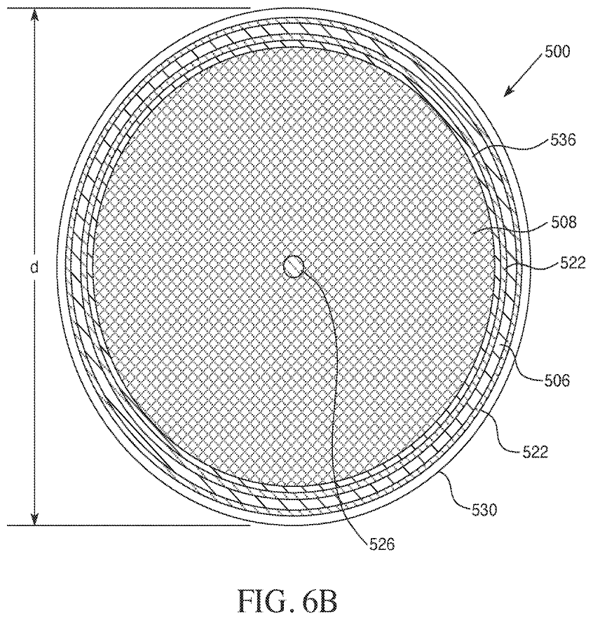

U.S. Pat. No. 10,755,829 (the '829 patent), which is herein incorporated by reference it its entirety, discloses an irradiation target handling device and a method for moving a target into a nuclear reactor. The '829 patent discloses a device that enables material to be irradiated as needed to produce a desired transmutation product inside the core of a nuclear reactor. The device provides a means for monitoring neutron flux proximate to the material being irradiated to allow determination of the amount of transmutation product being produced. The device enables the irradiated material to be inserted into the reactor and held in place at desired axial positions, and to be withdrawn from the reactor when desired without shutting down the reactor. The majority of the device may be re-used for subsequent irradiations. The device also enables the simple and rapid attachment of unirradiated target material to the portion of the device that transmits the motive force to insert and withdraw the target material into and out of the reactor and the rapid detachment of the irradiated material from the device for processing. The method for moving a target material into and withdrawing the target material from a nuclear reactor is applicable to the present disclosure to move a Ra-226 containing target material into a nuclear reactor and withdraw the Ra-226 containing target material from the nuclear reactor (e.g., such as the irradiation target assembly 500 containing Ra-226 target material discussed below with respect to FIGS. 6A-6B). FIGS. 2-4 and the accompanying description below provide details related to various aspects of moving a target material into and withdrawing the target material from a nuclear reactor.

FIG. 2 illustrates a typical system for the insertion of the movable detectors 12 into a reactor core 14. Retractable thimbles 10, into which the detectors 12 are driven, are routed as shown in FIG. 2. The thimbles 10 are inserted into the reactor core 14 through conduits extending from the bottom of the reactor vessel 16 through a concrete shield area 18 and then up to a thimble seal table 20. Mechanical seals between the retractable thimbles and the conduits are provided at the seal table 20. The conduits 22 are essentially extensions of the reactor vessel 16, with the thimbles 10 allowing the insertion of the in-core instrumentation movable detectors 12. During operation, the thimbles 10 are stationary and will be retracted only under depressurized conditions during refueling or maintenance operations. Withdrawal of a thimble to the bottom of the reactor vessel is also possible if work is required on the vessel internals.

The drive system for insertion of the detectors 12 can include drive units 24, limit switch assemblies 26, 5-path rotary transfer devices 28, 10-path rotary transfer devices 30, and isolation valves 32. Each drive unit pushes a hollow helical-wrap drive cable into the core with a detector 12 attached to the leading end of the cable and a small diameter coaxial cable, which communicates the detector output, threaded through the hollow center back to the trailing end of the drive cable.

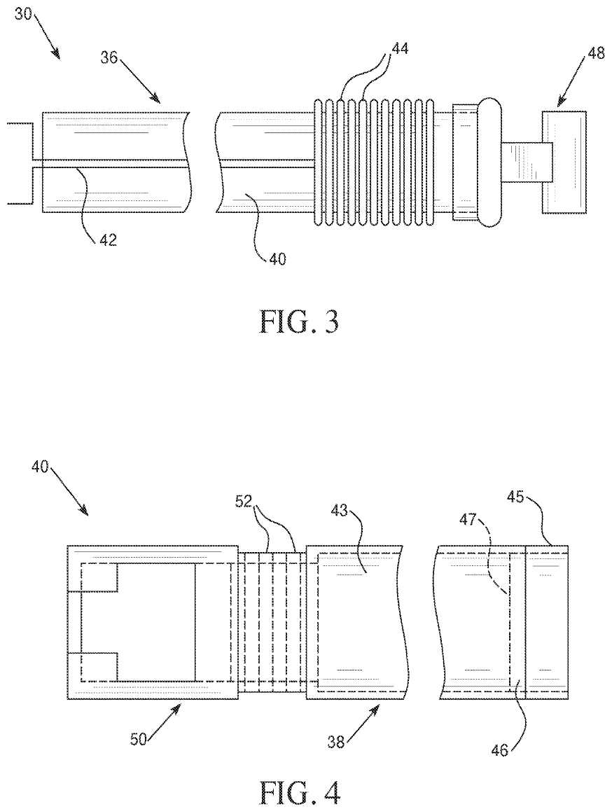

The thimbles 10 can be used for the production of irradiation desired neutron activation and transmutation products, such as isotopes used in medical procedures, or to generate prompt neutron capture gamma radiation using a material such as Gd-157. The isotope production cable described in FIGS. 3-4 below provides a means to insert and withdraw the material to be irradiated from inside the flux thimbles located in the reactor core 14.

Referring now to FIGS. 3-4, the isotope production cable assembly includes a driver cable assembly 36 and a target holder element 38. The drive cable assembly 36 includes a cable constructed to be compatible with the drive mechanism requirements for the existing cable drive systems used to insert and withdraw sensors 12 within commercial nuclear reactor cores 14, such as movable in-core detector system that is schematically shown in FIG. 2 and/or a traversing in-core probe (TIP) system. The drive cable assembly 36 interior contains the signal lead 42 for a self-powered detector element 44. The active portion of the self-powered detector 44 is a spiral wound around the exterior of the inserted end of the drive cable 40 with a length sufficient to provide a robust signal output and a minimum of axial position difference from end to end. The output from the self-powered detector 44 is used to identify the reactor flux at the self-powered detector position in the reactor core 14 to allow the axial position of the target material to be optimized.

The drive cable assembly 36, which is a replacement for an existing drive cable to which one of the detectors 12 was coupled to, attaches to a target holder element cable assembly 38 using the ball clasp arrangement (also known as a ball chain coupling) identified in FIGS. 3-4 by reference characters 48 and 50. The ball and clasp arrangement has a ball or male portion 48 connected to the reactor insertion end of the drive cable assembly 36. The clasp portion 50 is attached to a target material holder 43 on the target holder element cable Assembly 38 with connector pins 52. The ball portion 48 of the quick disconnect coupling is designed fit within and be detachably captured by the clasp portion 50. The target holder element cable assembly 38 comprises the target material holder 43, which is a hollow cylinder of a very thin metal mesh 47 that has a length sufficient to hold the desired amount of target material within the confines of the active reactor core 14. After the target material is withdrawn from the reactor, the target holder element cable assembly 38 may be easily and quickly disconnected from the drive cable assembly 36. The cap 45 indicated on the inserted end of the target holder element cable assembly 38 is held in place by a ring clamp 46. The ring clamp 46 is designed to be simple to remove. Once it is removed, the irradiated material may be removed from the inside of the target holder element cable assembly.

The devices, systems, and methods for moving a target material into and withdrawing the target material from a nuclear reactor discussed above and in the '829 Patent are applicable to the present disclosure to move an irradiation target assembly (e.g., irradiation target assembly 500) and/or a Ra-226 containing target material into a nuclear reactor and withdraw the Ra-226 containing target material from the nuclear reactor.

### Production of Ac-225 Using a Neutron Generator

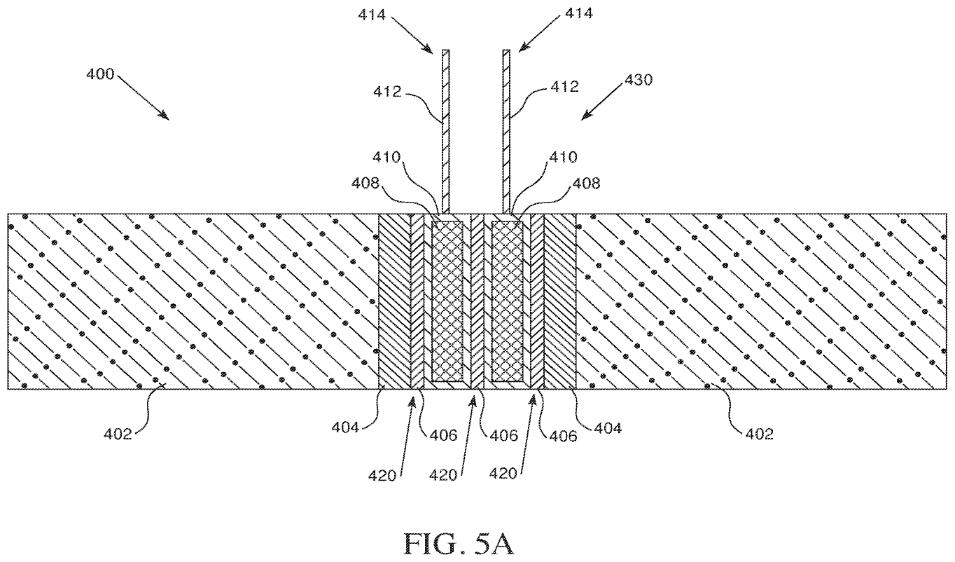

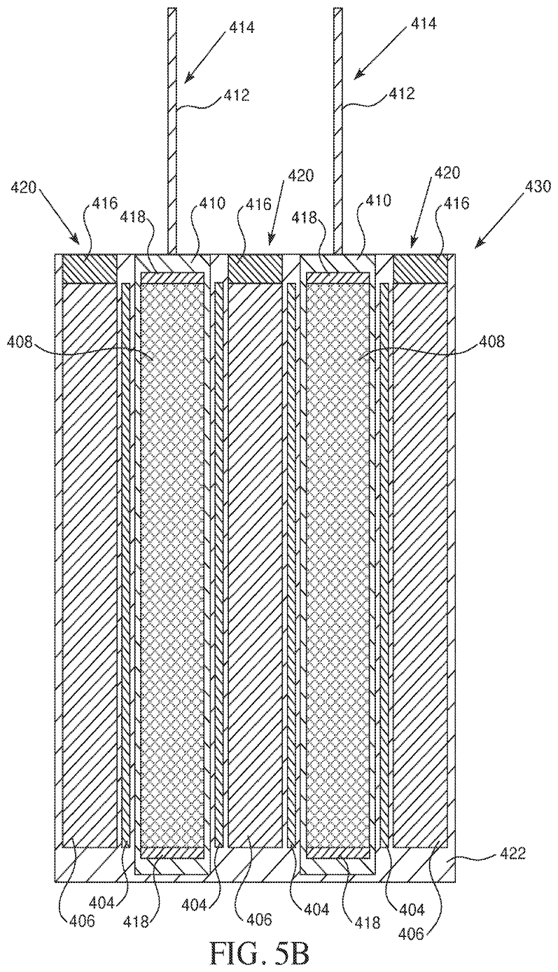

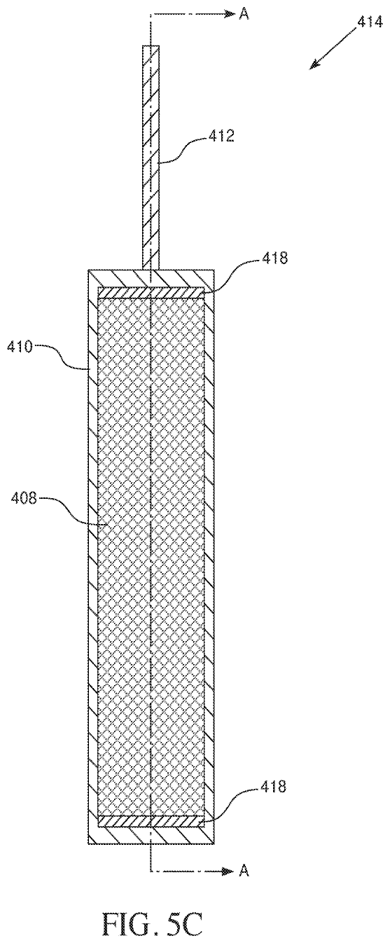

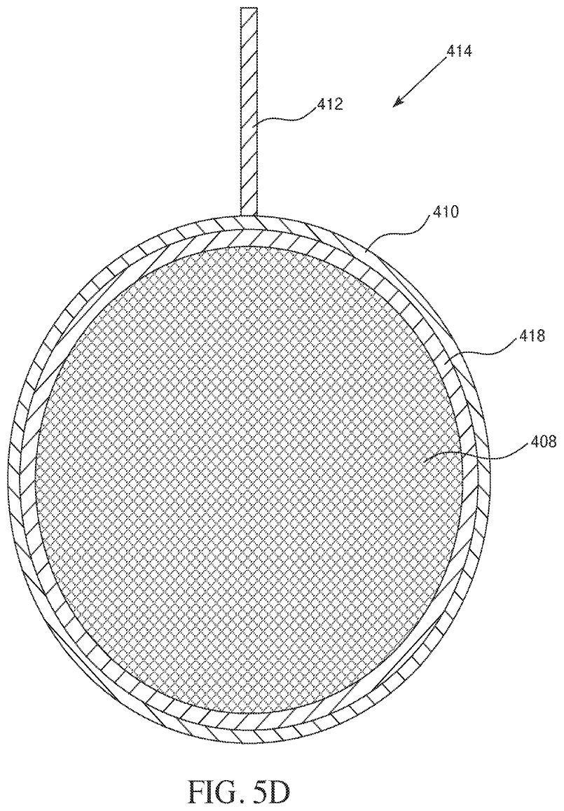

FIGS. 5A-5D illustrate a schematic representation of a system 400 using dual electronic neutron generators 402 that can be used to produce Ra-225 from irradiation targets containing Ra-226, according various aspects of the present disclosure. Although the system 400 includes two electronic neutron generators 402, the system 400 may be modified to include only one electronic neutron generator 402 or more than two electronic neutron generators 402. As shown in FIG. 5A, the system 400 includes dual electronic neutron generators 402 and a Ra-226 irradiation device 430. The dual electronic neutron generators 402 are arranged at opposite sides of the Ra-226 irradiation device 430 so that the neutrons generated by the dual electronic neutron generators 402 can irradiate a target material (e.g., a Gd-157 material) contained inside one or more than one irradiation target insert 420 of the Ra-226 irradiation device 430 to generate gamma radiation (e.g., gamma rays).

In some aspects, the target material (e.g., a Gd-157 target material) contained inside one or more than one irradiation target insert 420 can include Gd₂O₃ enriched in Gd-157. For example, the Gd₂O₃ can be enriched to have at least about 50 wt. %, at least about 60 wt. %, at least about 70 wt. %, at least about 80 wt. %, at least about 85 wt. %, at least about 87 wt. %, at least about 90 wt. %, about 87 wt. % to 100 wt. %, or about 87 wt. % of Gd-157.

FIG. 5B illustrates a detailed view of the schematic representation of the Ra-226 irradiation device 430. As shown in FIGS. 5A and 5B, the Ra-226 irradiation device 430 includes two Ra-226 inserts 414 and three irradiation target inserts 420. In other aspects, any number of Ra-226 inserts 414 and irradiation target inserts 420 may be used in the Ra-226 irradiation device 430. The Ra-226 inserts can each include a Ra-226 holder 410, a Ra-226 disk 408 placed in the Ra-226 holder 410, and a handling rod 412. The irradiation target inserts 420 can each include a Gd-157 disk 406. The irradiation device 430 can further include one or more than one neutron moderator 404, which includes a neutron moderating material such as graphite, water, and/or D₂O. As shown in the non-limiting aspect of FIGS. 5A, the Ra-226 irradiation device 430 is configured to have the components placed in the following order: the neutron moderator 404, the irradiation target insert 420, the Ra-226 insert 414, the irradiation target insert 420, the Ra-226 insert 414, the irradiation target insert 420, and the neutron moderator 404. The neutron moderator 404 may include a holder to hold and/or seal within the neutron moderating material. Placing the Ra-226 disks 408 in the Ra-226 holder 410 proximate to the sealed Gd-157 disks 406 can allow the Ra-226 material to be irradiated with high-energy gamma radiation produced from Gd-157 material of the Gd-157 disks 406, thereby producing Ra-225 from the Ra-226 material. Placing a layer of Gd-157 or a Gd-157 disk 406 between the Ra-226 disks 408 allows the photoneutrons produced by the high-energy gamma reaction in Ra-226 to produce additional gamma radiation to enhance the high-energy gamma radiation production. This can in turn enhance Ra-225 production.

The Ra-226 irradiation device 430 can be configured to maximize the amount of Ra-225 production by allow the gases (e.g., helium) produced during the irradiation of the Ra-226 target material and/or the irradiation target material (e.g., Gd-157) to expand without causing outgassing from the sealed Ra-226 disks 408 and/or the Ga-157 disks 420. The thickness and other dimensions of the Ra-226 irradiation device 430, the Ra-226 disks 408, and the Gd-157 disks can be optimized to maximize the production of Ra-225, for example, based on the average energy of gamma radiation produced by thermal neutron radiation of the Gd-157 material. Once a predetermined amount of Ra-225 is produced in the Ra-226 disks 408, the disks 408 can removed from the Ra-226 irradiation device 420 and replaced by fresh Ra-226 disks 408. The Ra-226 irradiation device 430 configuration illustrated in FIGS. 5A and 5B can alternatively or additionally allow the Gd-157 disks 406 to be replaced with fresh disks when the Gd-157 depletion levels have achieved a predetermined threshold. Gamma radiation levels surrounding the apparatus can be measured and used to determine the Ra-226 production level and/or the Gd-157 depletion level.

The Ra-226 disks 408 and/or the Gd-157 disks 406 may be in a shape of a cylinder, a cube, a cuboid, a hexagonal prism, an oval, or any other shapes. In one aspect, the Ra-226 disks 408 and the Gd-157 disks 406 can both be cylindrically in shape. In another aspect, the Ra-226 disks 408 and the Gd-157 disks 406 can both be in a shape of a cuboid. The shapes and dimensions of each of the Ra-226 irradiation device 430, the Ra-226 disks 408, and/or the Gd-157 disks (such as the diameters, the thicknesses, the heights, the lengths, the widths and other dimensions) can be optimized to maximize the production of Ra-225, for example, based on the average energy of gamma radiation produced by thermal neutron radiation of the Gd-157 material.

As shown in FIG. 5B, the Ra-226 irradiation device 430 can further include four neutron moderators 404 in between the Ra-226 inserts 414 and the irradiation target inserts 420. Thus, in some aspects, the Ra-226 irradiation device 430 can include two Ra-226 inserts 414 each including a Ra-226 holder 410, a Ra-226 disk 408 placed in each Ra-226 holder 410, a gas expansion gap 418 at the end(s) of each Ra-226 disk 408, and a handling rod 412. The Ra-226 irradiation device 430 can further include three irradiation target inserts 420 each including a Gd-157 disk 406 and a gas expansion gap 416 at the end(s) of each irradiation target insert 420. The Ra-226 irradiation device 430 can further four neutron moderators 404, with one of the neutron moderators 404 positioned at each interface between the Ra-226 insert 414 and the irradiation target insert 420, as shown in FIG. 5B. Each of the Ra-226 inserts 414 and the irradiation target inserts 420 can be separable from each other and the Ra-226 irradiation device 430 to allow the inserts 414, 420 to be inserted into and withdrawn from the Ra-226 irradiation device 430. The neutron moderators 404 may include a neutron moderating material such as graphite, water, and/or heavy water (D₂O).

FIG. 5C illustrates a detailed section view of the Ra-226 insert 414 of FIGS. 5A and 5B. FIG. 5D illustrates a schematic representation of a section view along line A-A of the Ra-226 irradiation insert 414 of FIG. 5C, where the Ra-226 insert 414 is cylindrical in shape. As shown in FIGS. 5C and 5D, the Ra-226 insert 414 includes a Ra-226 holder 410, a Ra-226 disk 408 placed in the Ra-226 holder 410, a handling rod 412, and gas expansion gaps 418 at ends of the Ra-226 disk 408 and/or surrounding the Ra-226 disk 408. This design with gas expansion gaps 418 in the Ra-226 insert 414 can maximize the amount of Ra-225 that can be produced from Gd-157 gamma sources and allows the expansion of the Ra-226 disk and the gases produced during the irradiation of Ra-226, such as Helium (He), radon, or other gases, to expand without causing outgassing from the sealed Ra-226 insert 414.

### Production of Ac-225 Using a Nuclear Reactor

In various aspects, this disclosure provides devices, systems, and methods for producing Ac-225 using nuclear reactors, such as a pressurized water reactor (PWR) or a boiling water reactor (BWR). FIGS. 6A and 6B provides a schematic illustration of an irradiation target assembly 500 containing Ra-226 that can be inserted and withdrawn into a reactor core in nuclear reactors using a Movable In-core Detector System (MIDS) common in many pressurized water reactor (PWR) designs (e.g., the MIDS system discuss above with respect to FIG. 2). Additionally or alternatively, the irradiation target assembly 500 irradiation target assembly can be inserted and withdrawn into a reactor core in nuclear reactors using a Traversing In-core Probe System (TIPS) common in many boiling water reactor (BWR) designs.

FIG. 6A illustrates a cross-sectional side view of an example irradiation target assembly 500, according to at least one aspect of the present disclosure. FIG. 6B illustrates a section view along the section line B-B of the irradiation target assembly 500 of FIG. 6A, according to at least one aspect of the present disclosure. The irradiation target assembly 500 includes a Ra-226 target insertion and extraction device 540; an irradiation target containment structure 550 (e.g., a Gd-157 target containment structure) including an irradiation target material 506 (e.g., a Gd-157 target material) and an irradiation target holder 522 (e.g., a Gd-157 target holder); and an outer rabbit sheath 530 with bullet nose. The outer rabbit sheath 530 encloses the Ra-226 target insertion and extraction device 540 and the irradiation target containment structure 550 except for at one end, as shown in FIG. 6A.

In some aspects, irradiation target material 506 (e.g., a Gd-157 target material) can include Gd₂O₃ enriched in Gd-157. For example, the Gd₂O₃ can be enriched to have at least about 50 wt. %, at least about 60 wt. %, at least about 70 wt. %, at least about 80 wt. %, at least about 85 wt. %, at least about 87 wt. %, at least about 90 wt. %, about 87 wt. % to 100 wt. %, or about 87 wt. % of Gd-157.

The Ra-226 target insertion and extraction device 540 fits inside the hollow cylinder of the irradiation target containment structure 550. The Ra-226 target insertion and extraction device 540 is separable from the irradiation target containment structure 550 and the outer rabbit sheath 530, and is freely movable and can be inserted into and withdrawn from the irradiation target containment structure 550. The Ra-226 target insertion and extraction device 540 can include a Ra-226 target material 508 including Ra-226; a Ra-226 holder 534 enclosing the Ra-226 target material 508; and a handling knob 524 connected to the Ra-226 holder 534. The handling knob 524 can facilitate the insertion of the Ra-226 target material 508 into the irradiation target containment structure 550 and/or the extraction of the Ra-226 target material 508 from the irradiation target containment structure 550.

The Ra-226 holder 534 includes a first wall 528, a central rod 526, a second wall 532, and a third wall 536, and encloses the Ra-226 target material 508. The central rod is along the central axis of the Ra-226 target insertion and extraction device 540. The Ra-226 target insertion and extraction device 540 can further include gas expansion gaps 518 at an end of the Ra-226 target insertion and extraction device 540. In one aspect, the Ra-226 target material 508 can be in the form of a single or multiple solid piece(s), or in the form of a powder compacted inside the Ra-226 holder 534. In another aspect, the Gd-157 material 506 can be in the firm of a single or multiple solid pieces(s), or in the form of a powder compacted inside the irradiation target holder 522.

The gas expansion gaps 518 in the Ra-226 target insertion and extraction device 540 can have a gas expansion volume of at least 1.0 cm³. This device design with the gas expansion gaps 518 in the Ra-226 target insertion and extraction device 540 can maximize the amount of Ra-225 that can be produced from irradiation target (e.g., Gd-157) gamma sources and can allow the expansion of the Ra-226 material and the gases produced during the irradiation of Ra-226, such as Helium (He), radon, or other gases, to expand without causing outgassing from the sealed Ra-226 target insertion and extraction device 540.

In one aspect, the irradiation target assembly 500 is cylindrical in shape. In another aspect, the Ra-226 target insertion and extraction device 540 is cylindrical in shape. In another aspect, the irradiation target containment structure 550 is cylindrical in shape and concentric with the Ra-226 target insertion and extraction device 540. In yet another aspect, the outer rabbit sheath 530 is cylindrical in shape with a closed bullet nose end enclosing the Ra-226 target insertion and extraction device 540 and the irradiation target containment 550, except for one end, as shown in FIG. 6A. The outer rabbit sheath 530 is concentric with the Ra-226 target insertion and extraction device 540 and the irradiation target containment structure 550. In one aspect, the outer rabbit sheath 530 is made of a metal or metal alloy such as SS-315 stainless steel, 316 stainless steel, Alloy-690, or a Zircalloy. The Ra-226 holder 534, the handling knob 524 and the irradiation target holder 522 can each be made of a metal or metal alloy SS-315 stainless steel, Alloy-690, or a Zircalloy.

In various aspects, the irradiation target assembly 500 uses a layer of Gd-157 material (i.e., the irradiation target material 506) inside the irradiation target assembly 500 and surrounding the Ra-226 target material 508 to produce gamma radiation with enough energy to irradiate Ra-226 to produce Ra-225. Without this configuration of Gd-157 surrounding the Ra-226 target material, fission spectrum gamma energies may be too low to initiate a photoneutron reaction in Ra-226. The irradiation target assembly 500 schematic shown on FIGS. 6A and 6B may be placed in a rabbit holder (e.g., of a MIDS, of a TIPS). The irradiation target containment structure 550 is separable from the Ra-226 target insertion and extraction device 540 and also the rabbit sheath 530 or “skin”. This allows the Ra-226 target insertion and extraction device 540 to be withdrawn from the irradiation target assembly 500 (i.e., the rabbit 500) and a new Ra-226 target insertion and extraction device 540 to be installed. The irradiation target containment structure 550 may additionally or alternatively be replaced when the depletion level reaches a predetermined threshold. The lengths, diameters and other dimensions of the irradiation target assembly 500, the target insertion and extraction device 540, and the irradiation target containment structure 550 can be determined based on the mass of Ra-226 target material 508 to be irradiated inside the available cross-sectional area of the Ra-226 target material 508. The irradiation target assembly 500 may be in a shape of a cylinder, a cube, a cuboid or other shapes. In one aspect, the irradiation target assembly 500 is in a cylinder shape, and the outside diameter of the rabbit 500 is determined by the maximum outside diameter of the fission chambers used by a movable in-core detection systems (MIDS) and/or traversing in-core probe systems (TIPS). The length of the Ra-226 target material 508 can be adjusted to achieve desired target mass content to maximize Ac-225 production.

The irradiation target assembly 500 can be moved into and from the reactor core of a nuclear reactor to generate gamma radiation and further to produce Ra-225 (decaying to Ac-225) from Ra-226. The gamma radiation levels surrounding the irradiation target assembly 500 can be measured and used to determine Ra-225 production and Gd-157 depletion levels. As noted above, Heibel et al. in the '829 Patent (e.g., with portions described above with respect to FIGS. 2-4), discloses an irradiation target handling device for moving a target into a nuclear reactor and also provides devices and systems for monitoring neutron flux proximate to the material being irradiated to allow determination of the amount of transmutation product being produced. The method and device of the '829 Patent for moving a target material into and from the reactor core of a nuclear reactor can be similarly applied to the irradiation target assembly 500 for moving the Ra-226 target material 508 into and from the reactor core of a nuclear reactor. The devices and systems for monitoring neutron flux proximate to the material being irradiated to allow determination of the amount of transmutation product being produced can also be similarly applied to the irradiation target assembly 500 to monitor and/or determine Ra-225 production and Gd-157 depletion levels.

The various devices, system, and methods of producing Ac-225 using electronic neutron generators and/or nuclear reactors discussed herein are capable of producing significant quantities of Ac-225. The devices, systems, and methods using electronic neutron generators to produce Ac-225 can allow more rapid post-processing of the irradiation target assemblies to minimize the decay losses of Ac-225. In some aspects, the various approaches using an electronic neutron generator do not require a nuclear reactor owner to participate in the production and may greatly benefit from advances in the maximum achievable neutron flux that can be obtained from electronic neutron generators. Various approaches involving the use of a nuclear reactor may allow a relatively higher Ac-225 activity density to be produced.

The devices, systems, and methods for producing Ac-225 discussed herein provide solutions to produce a very highly desired alpha-emitter (Ac-225) for use in Targeted Alpha Therapy (TAT). The current market price for Ac-225 can be over $8000 per millicurie (mCi) of activity. The devices, systems, and methods in this disclosure are capable of producing many thousands of mCi per year. The supply of Ra-226 required to support this production could be obtained from fracking operations. For example, Ra-226 can be recovered and recycled from the flowback water generated during Marcellus Shale natural gas production processes or from wastewater produced during Uranium mining.

Example Production Rate of Ra-225 and Ac-225 from Irradiation of Gd-157 by Thermal Neutrons

The macroscopic neutron cross section of Gd₂O₃ (Σₐ^{Gd}^{₂}^{O}^{₃}) is known to be 5945.5 cm⁻¹, assuming the gadolinium (Gd) is 100% gadolinium-157 (Gd-157) at 100% of the theoretical density of gadolinium (III) oxide (Gd₂O₃). The neutron reaction rate of the Gd-157 in Gd₂O₃ per cm³ (R) is given by the expression:

$$R = {\sum }_{a}^{{Gd}_{2} {O}_{3}} ϕ$$

The thermal neutron flux intensity from the electronic neutron generator (ϕ) is equal to 1 E8 n/cm²/s, and the target is a cylinder with a diameter of 4 inches and a thickness (T) of at least 1 inch. The value of R inside the target material is a function of the neutron intensity inside the target. A typical assumption is that the value of 5 is essentially constant inside the material. The extremely large thermal neutron absorption cross section of Gd-157 requires that the neutron intensity as a function of constant irradiation target area (A) and thickness (T) be considered to determine the neutron reaction rate R in the target. Equation 1 may be expressed:

$$R ( x ) = {\sum }_{a}^{{Gd}_{2} {O}_{3}} ϕ ( x )$$

The value of ϕ(x) may be expressed:

$$ϕ ( x ) = ϕ ( 0 ) {e}^{- x {\sum }_{a}^{{Gd}_{2} {O}_{3}}}$$

So the value of R at a distance x into the target is:

$$R ( x ) = {\sum }_{a}^{{Gd}_{2} {O}_{3}} ϕ ( 0 ) {e}^{- x {\sum }_{a}^{{Gd}_{2} {O}_{3}}}$$

The total reaction rate inside the target volume is then:

$$R = A {\sum }_{a}^{{Gd}_{2} {O}_{3}} ϕ ( 0 ) {\int }_{0}^{T} {e}^{- x {\sum }_{a}^{{Gd}_{2} {O}_{3}}} dx$$

Because of the large value of Σₐ^{Gd}^{₂}^{O}^{₃}, the integral rapidly goes to a value of 1/Σₐ^{Gd}^{₂}^{O}^{₃} for any appreciable value of T, so the value of R becomes Aϕ(0).

For the case where the thermal neutron flux supplied by the electronic neutron generator is 1×10⁸ n/cm²/s, and the cylindrical area of the target is 81.8 cm², the value of R is 8.1×10⁹ reactions/s inside the target. Since this corresponds to the total gamma emission rate, a total gamma activity in the target disk of 0.219 Ci can be achieved. This corresponds to 0.003 Ci/cm² of target. The corresponding total activity at a point 0.1 cm from the surface of the target disk is approximately 0.19 Ci. Using Rad Pro to convert the 7 MeV gamma activity to exposure rate in Roentgen/hour (R/hr), an exposure rate of 1.27×10⁷ R/hr is achieved. Assuming that for the fluid being irradiated, the conversion that 1 R/hr equals 0.01 Gray/hr (Gy/hr) in dose rate is used, this value corresponds to a dose rate of 127 kGy/hr at 0.1 cm from the target disk. However, since the fluid is inside a steel pipe with an assumed wall thickness of 5 mm, the dose seen by the water at contact with the inside of the pipe wall is about 4.5 kGy/hr.

For a purpose to sterilization of a fluid in a steel pipe, the total dose need to ensure sterilization is assumed to be 4 kGy. Thus the fluid will need to be exposed for over 1.13 hours for complete sterilization. Practical application of the gamma radiation will require the use of low flow rates in small diameter pipes in turbulent flow to ensure that the fluid can be sanitized in a relatively short section of pipe with the minimum number of irradiation devices.

It should be noted that the gamma radiation will also cause delta-radiation to be emitted from the pipe wall into the fluid. The total gamma activity of the target is 0.219 Ci. This corresponds to a total dose rate of 3.22E7 R/hr at the OD of the pipe over the target area. Based on the measured sensitivity of iron Self-Powered Detector elements to Co-60 gamma radiation, the sensitivity of the pipe wall to the 7 MeV gamma radiation will be approximately 9E-16 Amps/(R/hr)/mm². Assuming an effective surface area of 81.1 cm² (8110 mm²) per device, this would produce 0.00024 Amps worth of electrons. Since this corresponds to approximately 1.5E15 e⁻/cm²/s, this corresponds to a dose rate of about 2E5 kGy at the inside surface of the pipe wall over the irradiation target area. Consequently, the dose to the fluid supplied by the delta-radiation may significantly exceed the dose supplied by the gamma radiation at the pipe wall. It should be noted that the beta dose rate drops to essentially zero by 2 cm into the fluid in the pipe, so working with small, thin walled pipes with significant turbulent flow would be needed to take advantage of the delta-radiation dose provided by the gamma radiation.

The delta-radiation produced by the gamma radiation will also produce a large X-ray component caused by Bremsstrahlung interactions in the steel pipe. This will also provide a significant contribution to the radiation dose received by the fluid in the pipe. The dose rate to the fluid is proportional to the average X-ray energy, which is proportional to the average delta-radiation energy. The average delta-radiation energy is proportional to the average gamma radiation energy. Since the peak gamma radiation from Gd-157m is about 7 MeV, 7 MeV can be used as the average delta-radiation energy. In order to determine the X-ray dose rate in the fluid an effective X-ray production cross section per cm of wall thickness is needed to calculate the intensity of the X-ray radiation produced in the pipe wall.

The sum total of all the radiation dose production mechanisms may allow the practical use of the device design for the treatment of commercial and municipal wastewater.

This section provides a calculation to determine the production rate of Ra-225 and Ac-225 from the irradiation of Gd-157 by thermal neutrons. This section also provides a calculation of the expected reaction rate in Ra-226 from the device described in U.S. Provisional Application No. 63/166,718 and the net production of Ra-225 and Ac-225 as a function of irradiation time for both application of an electronic neutron generator and if the method described in in the '829 Patent is used. The calculation results indicate that thousands of mCi of Ac-225 can be produced using any of the approaches described in this disclosure.

Additional aspects of the present disclosure are provided below.

In various aspects, a device, system and method to produce Ac-225 using a gamma-radiation generator are disclosed herein. In one aspect, the gamma-radiation generator utilizes an electronic neutron generator to produce high energy prompt-capture gamma-radiation. In another aspect, the gamma-radiation generator utilizes a commercial nuclear reactor such as pressurized water reactor (PWR) and boiling water reactor (BWR).

In one aspect, a device, system and method to produce Ac-225 using a gamma-radiation generator utilizing an electronic neutron generator to produce high energy prompt-capture gamma-radiation are disclosed herein. The system comprises a device disclosed herein below for producing Ac-225 from Ra-226; and at least one monitor to measure the gamma radiation levels surrounding the device to thus monitoring the production of Ra-225 which decays to form Ac-225.

In one aspect, a device for producing Ac-225 using a gamma-radiation generator utilizing an electronic neutron generator to produce high energy prompt-capture gamma-radiation is disclosed herein. In one aspect, the device comprises: at least one electronic neutron generator configured to generate neutrons or a thermal neutron flux; a Ra-226 irradiation device; and two end neutron moderators.

The device is configured to direct the neutrons to irradiating the Ra-226 irradiation device. In one aspect, the Ra-226 irradiation device comprises a Ra-226 target material having Ra-226 and a gamma radiation generating material. In one aspect, the gamma generating material is Gd-157 or Hf-174, preferably Gd-157.

In one aspect, the Ra-226 irradiation device comprises at least one Ra-226 insert including a Ra-226 holder and a Ra-226 disk enclosed and hermetically sealed inside the Ra-226 holder; and at least one Gd-157 insert including a Gd-157 holder and a Gd-157 disk enclosed and sealed (preferably hermetically sealed) in the Gd-157 holder. The Ra-226 disk comprises a Ra-226 target material having at least about 30 wt. %, at least about 40 wt. %, at least about 50 wt. %, at least about 60 wt. %, at least about 70 wt. %, at least about 80 wt. %, at least about 90 wt. %, at least about 95 wt. %, or about 50-100 wt. % of Ra-226. The Gd-157 disk comprising a Gd-157 target material. The Gd-157 target material comprises gadolinium oxide (Gd₂O₃) enriched to have at least about 50 wt. %, at least about 60 wt. %, at least about 70 wt. %, at least about 80 wt. %, at least about 85 wt. %, at least about 87 wt. %, at least about 90 wt. % of Gd-157, about 87 wt. % to 100 wt. %, or about 87 wt. %. The Gd-157 target material has a predetermined mass and geometric properties controlled to deliver an optimized gamma dose rate and intensity to the Ra-226 insert being irradiated. In one aspect, the device is configured to direct neutrons generated by the electronic neutron generator to irradiate the Gd-157 target material sealed in the Gd-157 insert to produce high energy gamma radiation or gamma rays.

In one aspect, the two end neutron moderators each include a neutron moderating material having a predetermined mass and geometric properties to optimize a thermal neutron flux exposure in the Gd-157 disk sealed in the Gd-157 insert.

In one aspect, The Ra-226 irradiation device further comprises at least one inside neutron moderator. The inside neutron moderator comprises a neutron moderating material, such as water, heavy water (D₂O) or graphite. The neutron moderating material has a predetermined mass and geometric properties to optimize a thermal neutron flux exposure in the Gd-157 disk sealed in the Gd-157 insert.

In one aspect, the at least one electronic neutron generator is dual, three or more electronic neutron generators. The at least one Ra-226 insert is two, three or more Ra-226 inserts. The at least one Gd-157 insert is two, three, four or more Gd-157 inserts in one aspect. The at least one neutron moderator is two, three, four, five, six or more neutron moderators.

In one aspect, the Ra-226 irradiation device comprises: dual electronic neutron generators; a Ra-226 irradiation device. The Ra-226 irradiation device comprises: two Ra-226 inserts each including a Ra-226 disk and a Ra-226 holder; and three Gd-157 inserts each including a Gd-157 disk and a Gd-157 holder; and four inside neutron moderators, wherein the Ra-226 irradiation device is configured to have all the components adjacent or next to each other arranged in the order from left to right, a first right Gd-157 insert, a first inside neutron moderator, a first Ra-226, a second inside neutron moderator, a second Gd-157 insert, a third inside neutron moderator, a second Ra-226 insert, a fourth inside neutron moderator, and a third Gd-157 insert. This configuration of the Ra-226 irradiation device ensures each of the Ra-226 insert is sandwiched between two Gd-157 inserts to allow the photoneutrons produced by the high-energy gamma reaction in the Ra-226 insert to produce additional gamma radiation to enhance the high-energy gamma radiation production and in turn to enhance the production of Ra-225 which decays to Ac-225.

In one aspect, the device is configured to have all the components (including the dual electronic neutron generators, two end neutron moderators and the Ra-226 irradiation device) to be placed in the order from left to right, a first electronic neutron generator, a first end neutron moderator, the Ra-226 irradiation device; and a second neutron moderator, and a second electronic neutron generator.

In one aspect, the device further comprises a radiation shielding material configured to be positioned adjacent to and surrounding sides of the electronic neutron generator not adjacent to the Ra-226 irradiation device to minimize neutron and gamma radiations being emitted from surfaces not immediately adjacent to the end neutron moderators adjacent to the Ra-226 irradiation device. In one aspect, the radiation shielding material is lead (Pb).

In one aspect, each of the Ra-226 inserts and the Gd-157 inserts is separable from the other components of the Ra-226 irradiation device and is freely movable and capable of being inserted into or withdrawn from the Ra-226 irradiation device.

In one aspect, the Ra-226 insert further comprising a handling rod to facilitate the insertion of the Ra-226 inserts into the Ra-226 irradiation device, or withdrawn the Ra-226 inserts from the Ra-226 irradiation device.

In one aspect, each of the Ra-226 inserts has one or more gas expansion gaps. The one or more gas expansion gaps are at the top or bottom end or both ends of the Ra-226 disk, or surrounding the Ra-226 disk sealed in the Ra-226 insert. This device design is to maximizes the amount of Ra-225 that can be produced from Gd-157 gamma sources and allows the expansion of the Ra-226 disk and the gases produced during the irradiation of Ra-226, such as Helium, to expand without causing outgassing from the sealed Ra-226 disk. The one or more of the gas expansion gaps in the Ra-226 insert have a gas expansion volume of at least 1.0 cm³. This device design with the gas expansion gaps in the Ra-226 insert is to maximize the amount of Ra-225 that can be produced from Gd-157 gamma sources and allows the expansion of the Ra-226 disk and the gases produced during the irradiation of Ra-226, such as Helium (He), radon, or other gases, to expand without causing outgassing from the sealed Ra-226 insert.

In one aspect, each of the Gd-157 inserts may have one or more expansion gaps. The one or more gas expansion gaps are at the top or bottom end or both ends of the Gd-157 disk, or surrounding the Gd-157 disk sealed in the Gd-157 insert. This device design with expansion gaps in the Gd-157 insert is to maximize the amount of Ra-225 that can be produced from Gd-157 gamma sources and allows the expansion of the Gd-157 disk and any possible gases produced during the irradiation of Gd-157 to expand without causing outgassing from the sealed Gd-157 insert.

In one aspect, the device further comprises a monitor to measure the gamma radiation levels surrounding the device to monitor Ra-225 production and Gd-157 depletion levels. The device is configured so that the Ra-226 insert can be replaced with a fresh Ra-226 insert when the production of Ra-225 in the Ra-226 insert has risen above a predetermined level. The device is configured so that the Gd-157 insert can be replaced with a fresh Gd-157 insert when the Gd-157 depletion level has risen above a predetermined level.

In one aspect, the device does not include an electronic neutron generator. The neutron generator is provided separately. In one aspect, the device does not include a monitor to measure the gamma radiation level surrounding the device. The monitors are provided separately.

In one aspect, the device may further comprises a neutron shielding material. the radiation shielding material is configured to be positioned adjacent to and surrounding sides of the electronic neutron generator not adjacent to the Ra-226 irradiation device to minimize radiations being emitted from surfaces not immediately adjacent to the irradiation target material. In one aspect, the radiation shielding material is lead (Pb).

In one aspect, an apparatus, a process to produce high energy gamma radiation using electronic neutron generators are disclosed herein. In one aspect, the high energy gamma radiation is used irradiating Ra-226 target material to produce Ac-225 from Ra-226.

In one aspect, the apparatus comprises at least an electronic neutron generator to generate a thermal neutron flux; and an assembly including an irradiation target material. The assembly including the irradiation target material is configured to be positioned adjacent to one end of the electronic neutron generator, such as the fusion reaction source end of the electronic neutron generator. The neutron flux is directed to and interacts with the irradiation target material to produce neutron prompt-capture high energy gamma radiation in the irradiation target material. In one aspect, the irradiation target material is Gd-157 target material. The assembly includes at least one Gd-157 insert comprising the Gd-157 target material sealed in Gd-157 insert. In one aspect, the assembly is the Ra-226 irradiation device discussed above and the irradiation target material is configured to be included in the Ra-226 irradiation device.

In one aspect, the apparatus for producing the high energy gamma radiation may include an electronic neutron generator configured to generate a thermal neutron flux; an assembly including an irradiation target material; and a radiation shielding material for shielding neutron and/or gamma radiations. In one aspect, the assembly including the irradiation target material is configured to be positioned adjacent and next to the fusion reaction source end of the electronic neutron generator. The apparatus is configured to direct the neutron flux to the assembly including the irradiation target material, so that the irradiation target material captures and interacts with at least part of the neutron flux to produce neutron prompt-capture high energy gamma radiation. The neutron and gamma radiation shielding material is configured to be positioned adjacent to and surrounding sides of the electronic neutron generator not adjacent to the assembly including the irradiation target material to minimize radiations being emitted from surfaces not immediately adjacent to the irradiation target material. In one aspect, the radiation shielding material may include lead (Pb). In one aspect, the irradiation target material is Gd-157 target material. The assembly includes at least one Gd-157 insert comprising the Gd-157 target material sealed in the Gd-157 insert. In one aspect, the assembly is the Ra-226 irradiation device discussed above and the irradiation target material is configured to be included in the Ra-226 irradiation device.

In one aspect, the apparatus is configured to direct the high energy gamma radiation to an object. In one aspect, the object comprises Ra-226 target material. In one aspect, the object comprises a Ra-226 insert having the Ra-226 target material sealed in the Ra-226 insert. In one aspect, the object is part of the assembly discussed above and the assembly is the Ra-226 irradiation device discussed above.

In one aspect, the apparatus may further include a neutron moderating material. In one aspect, the neutron moderating material is configured to be positioned between the fusion reaction source end of the electronic neutron generator and the assembly. In one aspect, the neutron moderating material may include or be graphite, water or heavy water.

In one aspect, the amount and geometric properties of the neutron moderating material are controlled to optimize the thermal neutron flux exposure in the irradiation target material (the Gd-157 target material).

In one aspect, the irradiation target material may include a neutron-capture material, such as a Gadolinium-157 (Gd-157) material or some other material with a very high thermal neutron capture cross section that emits prompt capture gamma radiation. In one aspect, the Gd-157 material may include gadolinium oxide (Gd₂O₃) enriched to have about 87% of Gd-157, at least about 50%, at least about 87%, or between about 87% and 100% of Gd-157. The Gd-157 material captures and interacts with the neutrons generated by the electronic neutron generator to produce high energy gamma radiation.

In one aspect, a mass and geometric properties of the Gd-157 material are controlled to optimize a gamma dose rate and energy received by the object.

In one aspect, the apparatus does not include an electronic neutron generator, and the electronic neutron generator is provided separately from the device.

In one aspect, a method for producing high energy gamma radiations is provided. The method may include one or more steps of: providing an electronic neutron generator; generating a neutron flux by the electronic neutron generator; directing the neutron flux to an irradiation target material; and producing neutron prompt-capture gamma radiation in the irradiation target material through interactions between the neutron flux and the irradiation target material. In one aspect, the method further comprises directing the gamma radiation to an object. In one aspect, the irradiation target material is configured to be positioned adjacent to one end of the electronic neutron generator, and between the end of the electronic neutron generator and the object.

In one aspect, the method may further include using a radiation shielding material configured to be positioned adjacent to and surrounding sides of the electronic neutron generator not adjacent to the irradiation target material to minimize radiation being emitted from surfaces not immediately adjacent to the irradiation target material.

In one aspect, the method may further include adding a neutron moderating material between the end of the electronic neutron generator closest to the irradiation target material and the irradiation target material.

In one aspect, a device, system and method for producing Ac-225 from Ra-226 using high energy gamma radiation generated above are disclosed herein.

In one aspect, the method producing Ac-225 from Ra-226 using the high energy gamma radiation may include one or more steps of: providing an electronic neutron generator; generating a neutron flux by the electronic neutron generator; directing the neutron flux to an irradiation target material; producing neutron prompt-capture gamma radiation in the irradiation target material through interactions between the neutron flux and the irradiation target material; directing the gamma radiation to a Ra-226 target material to be irradiated; irradiating the Ra-226 target material to produce Ra-225 from Ra-226 in the Ra-226 insert. In one aspect, the irradiation target material is configured to be positioned adjacent to one end of the electronic neutron generator, and between the end of the electronic neutron generator and the Ra-226 target material.

In one aspect, the method may further include controlling a mass and geometric properties of the irradiation target material to optimize a gamma dose rate and intensity received by the Ra-226 target material being irradiated.

In one aspect, the irradiation target material is configured to be included and sealed in an Gd-157 insert and the Ra-226 target material is configured to be included and sealed in a Ra-226 insert.

In one aspect, the method further comprises removing the Ra-226 insert from the irradiation of the gamma radiation; and allowing the Ra-225 in the Ra-226 to decay to produce Ac-225.

In one aspect, the method may further include measuring gamma radiation level surrounding the Gd-157 insert and the Ra-226 insert; determining the measured gamma radiation level is below a predetermined level; removing the Ra-226 insert from the gamma radiation; replacing the Ra-226 insert with a fresh Ra-226 insert; and replacing the Gd-157 insert with a fresh Gd-157 insert.

In one aspect, the method may further include using a radiation shielding material configured to be positioned adjacent to and surrounding sides of the electronic neutron generator not adjacent to the irradiation target material to minimize radiation being emitted from surfaces not immediately adjacent to the irradiation target material.

In one aspect, the method may further include adding a neutron moderating material between the end of the electronic neutron generator closest to the irradiation target material and the irradiation target material.

In one aspect, the method may further include controlling an amount and geometric properties of the neutron moderating material to optimize the neutron flux exposure in the irradiation target material.

In one aspect, the irradiation target material has a cross section for thermal neutron capture in amount of approximately 257000 barns (b).

In one aspect, a dose rate of the gamma radiation received by the Ra-226 target material is not less than about 625 R/second or 2.25×10⁶ R/hour.

In one aspect of the present disclosure, a system, device and method for producing Ac-225 from Ra-226 using commercial nuclear reactor are provided herein. The system comprises an Irradiation Target Assembly. The Irradiation Target Assembly comprises a Ra-226 target insertion and extraction device; an irradiation target containment structure including an irradiation target material and an irradiation target holder; and an outer rabbit sheath with a closed end bullet nose, wherein the outer rabbit sheath enclosing the the -226 target insertion and extraction device and the irradiation target containment structure except for the top ends.

In one aspect, the irradiation target containment structure is a Gd-157 containment structure. The irradiation target material includes a Gd-157 target material. The irradiation target holder is a Gd-157 holder.

In one aspect, the Ra-226 target insertion and extraction device comprises a Ra-226 target material including Ra-226; a Ra-226 holder enclosing and sealing the Ra-226 target material; and a handling knob connected to the Ra-226 holder. The handling knob facilitate the insertion of the Ra-226 target material into the Gd-157 containment structure, and also the extraction of the Ra-226 target material from the Gd-157 containment structure. The Ra-226 holder encloses and hermetically seals the Ra-226 target material. The central rod is along the central axis of the Ra-226 target insertion and extraction device. The Ra-226 target insertion and extraction device further comprises gas expansion gaps at the top end of the Ra-226 target insertion and extraction device. The gas expansion gaps may have a gas expansion volume of at least 1.0 cm³. This device design with the gas expansion gaps in the Ra-226 target insertion and extraction device is to maximize the amount of Ra-225 that can be produced from Gd-157 gamma sources and allows the expansion of the Ra-226 and the gases produced during the irradiation of Ra-226, such as Helium (He), radon, or other gases, to expand without causing outgassing from the sealed Ra-226 target insertion and extraction device.

In one aspect, the Ra-226 target material is a solid, or a powder compacted inside the Ra-226 holder. The Gd-157 material is in a solid form, or is a powder compacted inside the Gd-157 holder.

In one aspect, the irradiation target assembly is in a cylinder shape. The Ra-226 target insertion and extraction device is in a cylinder shape. The Gd-157 containment structure is in a hollow cylinder shape concentric with the Ra-226 target insertion and extraction device. The outer rabbit sheath is in a hollow cylinder shape with a closed end bullet nose enclosing and sealing the Ra-226 target insertion and extraction device and the Gd-157 containment structure except for the top ends, as shown in FIG. 6A. The outer rabbit sheath is concentric with the Ra-226 target insertion and extraction device and the Gd-157 containment structure. In one aspect, the outer rabbit sheath is made of a material such as SS-315 stainless steel, Alloy-690, or a Zircalloy. The Ra-226 holder 534, the handling knob 524 and the Gd-157 holder are each made of a material such as SS-315 stainless steel, Alloy-690, or a Zircalloy.

In one aspect, the Gd-157 containment structure, the Ra-226 target insertion and extraction device, and the rabbit sheath are separable from each other, which allows the Ra-226 target insertion and extraction device to be inserted into and withdrawn from the rabbit and a new Ra-226 target insertion and extraction device to be installed. The Gd-157 containment structure may also be replaced when the depletion level increases beyond desired levels. The lengths, diameters and other dimensions of the irradiation target assembly, the target insertion and extraction device and Gd-157 containment structure are determined based on the mass of Ra-226 target material to be irradiated inside the available cross-sectional area of the Ra-226 target material.

In one aspect, the system may further comprises a commercial nuclear reactor such as a pressurized water reactor (PWR); and a Movable Incore Detector System (MIDS) common in many pressurized water reactor (PWR) designs as disclosed by Heibel et al. (U.S. Pat. No. 10,755,829 (the '829 Patent), which is herein incorporated by reference herein in its entirety.

In one aspect, the irradiation target assembly may be in a shape of a cylinder. The outside diameter of the rabbit is determined by the maximum outside diameter of the fission chambers used by Movable Incore Detector System (MIDS) common in many pressurized water reactor (PWR) designs as disclosed in the '829 Patent. The length of the Ra-226 target material can be adjusted to achieve desired target mass content to maximize Ac-225 production.

In one aspect, the system further comprises monitors to measure the neutron flux and/or gamma radiation level in the vicinity of the irradiation target assembly to allow the determination of the Ra-225 production level and the Gd-157 target material depletion level. The measured data can be used to determine whether to replace the Ra-226 target insertion and extraction device and/or the Gd-157 containment structure as compared to a predetermined level.

In one aspect, a method for producing Ac-225 from Ra-226 using a commercial nuclear reactor and the system discussed above is provided. The method comprises: generating a neutron flux; directing the neutron flux to an irradiation target containment structure including an irradiation target material and an irradiation target holder; producing neutron prompt-capture gamma radiation in the irradiation target material through interactions between the neutron flux and the irradiation target material; directing the gamma radiation to a Ra-226 target material to be irradiated; irradiating the Ra-226 target material to produce Ra-225 from Ra-226 in the Ra-226 target material.

In one aspect, the method further comprises removing the Ra-226 target material from the gamma radiation and allowing the Ra-225 in the irradiated Ra-226 target material to decay to produce Ac-225.

In one aspect, the irradiation target containment structure and the Ra-226 target material are included in the irradiation target assembly as discussed above.

In one aspect, the method further comprises providing a nuclear reactor having a reactor core such as a pressurized water reactor (PWR) or a boiling water reactor (BWR), the nuclear reactor having a means to deliver the irradiation target assembly into the reactor core of the nuclear reactor. In one aspect, the neutron reflex is generated by the nuclear reactor.

In one aspect, the method further comprises measuring the gamma radiation level surrounding the irradiation target assembly to determine the Gd-157 depletion level; determining that the Gd-157 depletion level is above a predetermined level; and replacing the Gd-157 containment structure; calculating the Ra-225 production amount; determining the production amount of the Ra-225 is above a predetermined amount; removing the irradiated Ra-226 insertion and extraction device; replacing with a fresh Ra-226 insertion and extraction device; allowing the Ra-225 in the irradiated Ra-226 insertion and extraction device to decay to produce Ac-225.

In one aspect, the method may further include controlling a mass and geometric properties of the Gd-157 target material to optimize a gamma dose rate and intensity received by the Ra-226 target material being irradiated.

In one aspect, the method may further include adding a neutron moderating material between the Ra-226 insertion and extraction device and the Gd-157 containment structure.

In one aspect, the method may further include controlling an amount and geometric properties of the neutron moderating material to optimize the neutron flux exposure in the irradiation target material.

Additional aspects of the present disclosure are provided in the clauses below.

Clause 1. A device for producing Ac-225 from Ra-226, the device comprising: an electronic neutron generator to generate a thermal neutron flux from an emission end of the electronic neutron generator; an irradiation target insert comprising an irradiation target material to generate gamma radiation in response to exposure to the thermal neutron flux generated by the electronic neutron generator, the irradiation target insert positioned proximate to the emission end of the electronic neutron generator; and a Ra-226 insert comprising a Ra-226 target material to produce Ra-225 in response to exposure to the gamma radiation generated by the irradiation target material.

Clause 2. The device of Clause 1, further comprising an end neutron moderator comprising a neutron moderating material to moderate the exposure of the irradiation target material to the thermal neutron flux, the end neutron moderator positioned between the irradiation target insert and the emission end of the electronic neutron generator.

Clause 3. The device of any of Clauses 1-2, wherein the irradiation target material comprises a Gadolinium-157 (Gd-157) material, and wherein the irradiation target insert is a Gd-157 insert.

Clause 4. The device of any of Clauses 1-3, wherein the Gd-157 material comprises gadolinium oxide (Gd₂O₃) enriched to comprise at least about 80 wt. % to 100 wt. % of Gd-157.

Clause 5. The device of any of Clauses 1-4, wherein the Gd₂O₃ is enriched to comprise about 87 wt. % of Gd-157.

Clause 6. The device of any of Clauses 1-5, wherein the irradiation target material is configured to deliver an optimized gamma dose rate and intensity to the Ra-226 insert.

Clause 7. The device of any of Clauses 1-6, wherein the electronic neutron generator is a first electronic neutron generator, wherein the end neutron moderator is a first end neutron moderator, wherein the Gd-157 insert is a first Gd-157 insert, and wherein Ra-226 insert is a first Ra-226 insert, the device further comprising: a second electronic neutron generator; a second end neutron moderator comprising the neuron moderating material; a second Gd-157 insert and a third Gd-157 insert each comprising the Gd-157 material; a second Ra-226 insert comprising the Ra-226 target material; and a first, a second, a third, and a fourth inside neutron moderator each comprising the neutron moderating material; wherein the first end neutron moderator is adjacent to the electronic neutron generator, the first Gd-157 insert is adjacent to the end neutron moderator, the first inside neutron moderator is adjacent to the first Gd-157 insert, the first Ra-226 insert is adjacent to the first inside neutron moderator; the second inside neutron moderator is adjacent to the first Ra-226 insert, the second Gd-157 insert is adjacent to the second inside neutron moderator; the third inside neutron moderator is adjacent to the second Gd-157 insert, the second Ra-226 insert is adjacent to the third inside neutron moderator, the fourth inside neutron moderator is adjacent to the second Ra-226 insert, the third Gd-157 insert is adjacent to the fourth inside neutron moderator, the second end neutron moderator is adjacent to the third Gd-157 insert, and the second electronic neutron generator is adjacent to the second end neutron moderator.

Clause 8. The device of any of Clauses 1-7, wherein each of the first, the second, and the third Gd-157 inserts and each of the first and the second Ra-226 inserts are removably inserted into the device.

Clause 9. The device of any of Clauses 1-8, further comprising a monitor configured to measure a level of the gamma radiation to determine at least one of a depletion level of the Gd-157 material or a production amount of the Ra-225.

Clause 10. A method for producing Ac-225 from Ra-226, the method comprising: generating neutron flux using an electronic neutron generator; producing gamma radiation by exposing an irradiation target material to the neutron flux; and producing Ra-225 by irradiating a Ra-226 insert comprising a Ra-226 target material with the gamma radiation.

Clause 11. The method of Clause 10, further comprising shielding the neutron flux using a radiation shielding material at least partially surrounding the electronic neutron generator.

Clause 12. The method of any of Clauses 10-11, further comprising moderating the neutron flux using a neutron moderating material positioned between the electronic neutron generator and the irradiation target material.

Clause 13. The method of any of Clauses 10-12, further comprising monitoring at least one of a depletion level of the irradiation target material or a Ac-225 production amount using a monitor configured to measure a level of the gamma radiation.

Clause 14. A system for producing Ac-225 from Ra-226, the system comprising: a nuclear reactor comprising reactor core; and an irradiation target assembly insertable into the reactor core, the irradiation target assembly comprising: a Ra-226 target insert and extraction device comprising: a Ra-226 material comprising Ra-226; and a Ra-226 holder enclosing and sealing the Ra-226 material; an irradiation target containment structure comprising: an irradiation target material; and an irradiation target holder enclosing and sealing the irradiation target material, wherein the irradiation target containment structure at least partially surrounds the Ra-226 target insert and extraction device; and an outer rabbit sheath comprising a closed end, wherein the outer rabbit sheath at least partially surrounds the irradiation target containment structure.

Clause 15. The system of Clause 14, wherein the irradiation target material comprises a Gd-157 material.

Clause 16. The system of any of Clauses 14-15, wherein the irradiation target assembly further comprises at least one gas expansion gap.

Clause 17. The system of any of Clauses 14-16, wherein the Ra-226 material and the irradiation target material are in a powder form.

Clause 18. The system of any of Clauses 14-17, wherein the Ra-226 target insertion and extraction device is cylindrical in shape, wherein the irradiation target containment structure is cylindrical in shape and concentric with the Ra-226 target insertion and extraction device, and wherein the outer rabbit sheath cylindrical in shape and comprises a closed end enclosing the Ra-226 target insertion and extraction device and the irradiation target containment structure.

Clause 19. The system of any of Clauses 14-18, further comprising one or more monitors configured to measure a level of gamma radiation level proximate to the irradiation target assembly to determine at least one of a Ra-225 production amount or an irradiation target material depletion level.

Clause 20. The system of any of Clauses 14-19, wherein the Ra-226 target insertion and extraction device and the irradiation target containment structure are each removably inserted into the irradiation target assembly.

Clause 21. A method for producing Ac-225 from Ra-226, the method comprising: inserting an irradiation target assembly into a core of a nuclear reactor, the irradiation target assembly comprising a Ra-226 material and an irradiation target material; generating neutron flux in the core of the nuclear reactor; producing gamma radiation by exposing an irradiation target material to the neutron flux; and producing Ra-225 by irradiating the Ra-226 with the gamma radiation.

Clause 22. The method of Clause 21, further comprising: determining at least one of a Ra-225 production amount or an irradiation target material depletion level by monitoring a level of the gamma radiation proximate to the irradiation target assembly.

Clause 23. The method of any of Clauses 21-22, further comprising: determining the irradiation target material depletion level satisfies a predetermined threshold; and replacing the irradiation target by removing the irradiation target material from the irradiation target assembly and inserting new irradiation target material into the irradiation target assembly.

Clause 24. The method of any of Clauses 21-23, further comprising: determining the Ra-225 production amount satisfies a predetermined threshold; removing the Ra-226 target material from the irradiation target assembly; and inserting new Ra-226 target material into the irradiation target assembly.

Clause 25. The method of any of Clauses 21-24, wherein the irradiation target material comprises Gd-157.

All patents, patent applications, publications, or other disclosure material mentioned herein and/or listed in any Application Data Sheet, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present disclosure has been described with reference to various exemplary and illustrative aspects. The aspects described herein are understood as providing illustrative features of varying detail of various aspects of the disclosed disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed disclosure. Accordingly, it will be recognized by persons having ordinary skill in the art that various substitutions, modifications or combinations of any of the exemplary aspects may be made without departing from the scope of the disclosure. In addition, persons skilled in the art will recognize, or be able to ascertain using no more than routine experimentation, many equivalents to the various aspects of the disclosure described herein upon review of this specification. Thus, the disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

In describing aspects and embodiments of the present application, specific terminology is employed for the sake of clarity. However, the disclosure is not intended to be limited to the specific terminology so selected. Nothing in this specification should be considered as limiting the scope of the present disclosure.

All examples presented are representative and non-limiting. The above-described aspects and embodiments may be modified or varied, without departing from the disclosure, as appreciated by those skilled in the art in light of the above teachings. It is therefore to be understood that, within the scope of the claims and their equivalents, the disclosure may be practiced otherwise than as specifically described.

Without further elaboration, it is believed that one skilled in the art can use the preceding description to utilize the claimed disclosures to their fullest extent. The examples, aspects and embodiments disclosed herein are to be construed as merely illustrative and not a limitation of the scope of the present disclosure in any way. It will be apparent to those having skill in the art that various changes and modifications may be made to the details of the above-described aspects and embodiments without departing from the underlying principles discussed. In other words, various modifications and improvements of the aspects and embodiments specifically disclosed in the description above are within the scope of the appended claims. For example, any suitable combination of features of the various aspects and embodiments described is contemplated.

1. A device for producing Actinium-225 (Ac-225) from Radium-226 (Ra-226), the device comprising:
an electronic neutron generator to generate a thermal neutron flux from an emission end of the electronic neutron generator;
an irradiation target insert comprising an irradiation target material to generate gamma radiation in response to exposure to the thermal neutron flux generated by the electronic neutron generator, the irradiation target insert positioned proximate to the emission end of the electronic neutron generator; and
a Ra-226 insert comprising a Ra-226 target material to produce Ra-225 in response to exposure to the gamma radiation generated by the irradiation target material.

2. The device of claim 1, further comprising an end neutron moderator comprising a neutron moderating material to moderate the exposure of the irradiation target material to the thermal neutron flux, the end neutron moderator positioned between the irradiation target insert and the emission end of the electronic neutron generator.

3. The device of claim 2, wherein the irradiation target material comprises a Gadolinium-157 (Gd-157) material, and wherein the irradiation target insert is a Gd-157 insert.

4. The device of claim 3, wherein the Gd-157 material comprises gadolinium oxide (Gd₂O₃) enriched to comprise at least about 80 wt. % to 100 wt. % of Gd-157.

5. The device of claim 4, wherein the Gd₂O₃ is enriched to comprise about 87 wt. % of Gd-157.

6. The device of claim 1, wherein the irradiation target material is configured to deliver an optimized gamma dose rate and intensity to the Ra-226 insert.

7. The device of claim 3, wherein the electronic neutron generator is a first electronic neutron generator, wherein the end neutron moderator is a first end neutron moderator, wherein the Gd-157 insert is a first Gd-157 insert, and wherein Ra-226 insert is a first Ra-226 insert, the device further comprising:
a second electronic neutron generator;
a second end neutron moderator comprising the neuron moderating material;
a second Gd-157 insert and a third Gd-157 insert each comprising the Gd-157 material;
a second Ra-226 insert comprising the Ra-226 target material; and
a first, a second, a third, and a fourth inside neutron moderator each comprising the neutron moderating material;
wherein the first end neutron moderator is adjacent to the electronic neutron generator, the first Gd-157 insert is adjacent to the end neutron moderator, the first inside neutron moderator is adjacent to the first Gd-157 insert, the first Ra-226 insert is adjacent to the first inside neutron moderator; the second inside neutron moderator is adjacent to the first Ra-226 insert, the second Gd-157 insert is adjacent to the second inside neutron moderator; the third inside neutron moderator is adjacent to the second Gd-157 insert, the second Ra-226 insert is adjacent to the third inside neutron moderator, the fourth inside neutron moderator is adjacent to the second Ra-226 insert, the third Gd-157 insert is adjacent to the fourth inside neutron moderator, the second end neutron moderator is adjacent to the third Gd-157 insert, and the second electronic neutron generator is adjacent to the second end neutron moderator.

8. The device of claim of 7, wherein each of the first, the second, and the third Gd-157 inserts and each of the first and the second Ra-226 inserts are removably inserted into the device.

9. The device of claim of 1, further comprising a monitor configured to measure a level of the gamma radiation to determine at least one of a depletion level of the Gd-157 material or a production amount of the Ra-225.

10. A method for producing Ac-225 from Ra-226, the method comprising:
generating neutron flux using an electronic neutron generator;
producing gamma radiation by exposing an irradiation target material to the neutron flux; and
producing Ra-225 by irradiating a Ra-226 insert comprising a Ra-226 target material with the gamma radiation.

11. The method of claim 10, further comprising shielding the neutron flux using a radiation shielding material at least partially surrounding the electronic neutron generator.

12. The method of claim 10, further comprising moderating the neutron flux using a neutron moderating material positioned between the electronic neutron generator and the irradiation target material.

13. The method of claim 10, further comprising monitoring at least one of a depletion level of the irradiation target material or a Ac-225 production amount using a monitor configured to measure a level of the gamma radiation.

14. A system for producing Ac-225 from Ra-226, the system comprising:
a nuclear reactor comprising reactor core; and
an irradiation target assembly insertable into the reactor core, the irradiation target assembly comprising:
a Ra-226 target insertion and extraction device comprising:
a Ra-226 material comprising Ra-226; and
a Ra-226 holder enclosing and sealing the Ra-226 material;
an irradiation target containment structure comprising:
an irradiation target material; and
an irradiation target holder enclosing and sealing the irradiation target material, wherein the irradiation target containment structure at least partially surrounds the Ra-226 target insertion and extraction device; and
an outer rabbit sheath comprising a closed end, wherein the outer rabbit sheath at least partially surrounds the irradiation target containment structure.

15. The system of claim 14, wherein the irradiation target material comprises a Gd-157 material.

16. The system of claim 14, wherein the irradiation target assembly further comprises at least one gas expansion gap.

17. The system of claim 15, wherein the Ra-226 material and the irradiation target material are in a powder form.

18. The system of claim 14, wherein the Ra-226 target insertion and extraction device is cylindrical in shape, wherein the irradiation target containment structure is cylindrical in shape and concentric with the Ra-226 target insertion and extraction device, and wherein the outer rabbit sheath cylindrical in shape and comprises a closed end enclosing the Ra-226 target insertion and extraction device and the irradiation target containment structure.

19. The system of claim 15, further comprising one or more monitors configured to measure a level of gamma radiation level proximate to the irradiation target assembly to determine at least one of a Ra-225 production amount or an irradiation target material depletion level.

20. The system of claim 15, wherein the Ra-226 target insertion and extraction device and the irradiation target containment structure are each removably inserted into the irradiation target assembly.

21. A method for producing Ac-225 from Ra-226, the method comprising:
inserting an irradiation target assembly into a core of a nuclear reactor, the irradiation target assembly comprising a Ra-226 material and an irradiation target material;
generating neutron flux in the core of the nuclear reactor;
producing gamma radiation by exposing the irradiation target material to the neutron flux; and
producing Ra-225 by irradiating the Ra-226 material with the gamma radiation.

22. The method of claim 21, further comprising:
determining at least one of a Ra-225 production amount or a irradiation target material depletion level by monitoring a level of the gamma radiation proximate to the irradiation target assembly.

23. The method of claim 22, further comprising:
determining the irradiation target material depletion level satisfies a predetermined threshold; and
replacing the irradiation target by removing the irradiation target material from the irradiation target assembly and inserting new irradiation target material into the irradiation target assembly.

24. The method of claim 22, further comprising:
determining the Ra-225 production amount satisfies a predetermined threshold;
removing the Ra-226 target material from the irradiation target assembly; and
inserting new Ra-226 target material into the irradiation target assembly.

25. The method of claim 21, wherein the irradiation target material comprises Gd-157.
